(19) United States
(12) Patent Application Publication
(10) Pub. No.: US 2026/0116817 A1
(43) Pub. Date: Apr. 30, 2026

(54) CONTROLLING CHEMICALLY TEMPERED GLASS PARTICLE SIZE BY SHAPE MODIFICATION

(71) Applicant: Honeywell Federal Manufacturing & Technologies, LLC, Kansas City, MO (US)

(72) Inventors: Rachel Leigh Grodsky, Raymore, MO (US); James A. Colby, Independence, MO (US)

(21) Appl. No.: 19/375,847

(22) Filed: Oct. 31, 2025

Related U.S. Application Data
(60) Provisional application No. 63/714,424, filed on Oct. 31, 2024.

(51) Int. Cl. C03C 21/00; C03C 3/083

(52) U.S. Cl. CPC C03C 21/002; C03C 3/083; C03C 2201/32

(57) ABSTRACT

Systems, methods, and apparatuses for controlling the broken particle size of tempered glass are disclosed. A glass piece may be formed to have one or more bends, each bend having a radius. A larger radius may result in smaller broken particles relative to a smaller radius. The formation of bends may increase the brittleness of the tempered glass piece relative to a flat piece of tempered glass piece. The bends may be formed via slumping. After forming the bends, the glass piece may undergo an ion exchange process to strengthen the glass and form the tempered glass. The ion exchange time and ion exchange temperature may be adjusted to control the broken particle size. Increasing any of the ion exchange time or the ion exchange temperature may yield broken particles of large sizes.

### CROSS-REFERENCE TO RELATED APPLICATIONS

This patent application is a non-provisional application claiming priority benefit, with regard to all common subject matter, of U.S. Provisional Patent Application No. 63/714,424, filed Oct. 31, 2024, and entitled “CONTROLLING ENERGETIC GLASS PARTICLE SIZE BY SHAPE MODIFICATION.” The above-referenced application is hereby incorporated by reference in its entirety into the present application.

### STATEMENT OF GOVERNMENT SUPPORT

This invention was made with government support under contract number DE-NA-0002839 awarded by the United States Department of Energy/National Nuclear Security Administration. The government has certain rights in the invention.

### BACKGROUND

### 1. Field

Embodiments of the present disclosure generally relate to chemically tempered glass. More specifically, embodiments of the present disclosure relate to controlling the particle size of tempered glass when broken.

### 2. Related Art

Chemically tempered glass is glass that breaks into particles when energy (e.g., mechanical, electrical, chemical, or thermal) is applied. Specifically, tempered materials typically break energetically at a pre-known threshold of applied energy. In contrast, non-tempered materials typically deform elastically or break non-energetically when energy is applied. Tempered glass is often used to avoid injuries in cars and in other applications that utilize large pieces of glass that are at a risk of being damaged and subsequently shattering. Curved pieces of glass may break more energetically relative to a flat piece of glass. In some cases, the curved glass may also be easier to break than a flat piece of glass. Accordingly, the use of curved glass is desirable when energetic breaking of glass is desired and/or breakage of the glass is desired. Further, it is desirable to control the breakage of the glass, such as the size of the glass particles when broken. Therefore, improvements in forming tempered glass are needed.

### SUMMARY

Embodiments of the present disclosure are generally directed to controlling the particle size of tempered glass when broken by slumping or otherwise shaping the glass into a desired shape (e.g., a curved shape), followed by ion exchanging, or other tempering processes, thereby creating stress gradients and forming the tempered glass. When the tempered glass is shaped to have a curve or bend, the particle size may further be controlled by selecting a degree of bend and/or a bend radius of each bend. A piece of glass, which may be initially flat, may be slumped into a shape that has a degree of bend, such as 90 degrees. The bend may also have a radius, which may be selected based on a desired resultant particle size of the glass when broken. Larger radii may result in a more energetic break and smaller broken particles, while smaller radii may result in a less energetic break and larger broken particles. After slumping, the now-bent glass may be ion exchanged to induce compressive stresses, yielding tempered glass. The broken particle size may be further controlled by the ion exchange time and/or the ion exchange temperature. Increasing any of the aforementioned parameters may result in the tempered glass being additionally stressed, may yield broken particles of smaller sizes, while lowering the radius of the bend may increase the broken particle size.

In some embodiments, the techniques described herein relate to a method for controlling a particle size of a tempered glass piece when broken. In some embodiments, the method includes slumping a glass piece into a bent shape having at least one bend, the at least one bend having a degree of bend and a bend radius. In some embodiments, the degree of bend controls the particle size of the tempered glass piece when broken. In some embodiments, the method further includes ion exchanging the glass piece to form the tempered glass piece.

In some embodiments, the techniques described herein relate to a method, wherein the degree of bend is 90 degrees.

In some embodiments, the techniques described herein relate to a method, wherein the bend radius is in a range of 0.25 inches to 4 inches.

In some embodiments, the techniques described herein relate to a method, wherein the at least one bend includes two or more bends.

In some embodiments, the techniques described herein relate to a method, wherein a first bend of the two or more bends includes a first degree of bend distinct from a second degree of bend of a second bend of the two or more bends.

In some embodiments, the techniques described herein relate to a method, wherein the tempered glass piece includes alkali aluminosilicate.

In some embodiments, the techniques described herein relate to a method, wherein the bend radius is greater than 4 inches.

In some embodiments, the techniques described herein relate to a method for controlling a particle size of a tempered glass piece when broken. In some embodiments, the method includes slumping a glass piece into a bent shape having a plurality of bends, each bend having a degree of bend and a bend radius. In some embodiments, the degree of bend and the bend radius of each bend control the particle size of the tempered glass piece when broken. In some embodiments, the method further includes ion exchanging the glass piece to form the tempered glass.

In some embodiments, the techniques described herein relate to a method, wherein the degree of bend of each bend is in a range of 60 degrees to 120 degrees.

In some embodiments, the techniques described herein relate to a method, wherein the bend radius of each bend is in a range of 0.25 inches to 4 inches.

In some embodiments, the techniques described herein relate to a method, further including heating the glass piece to a softening temperature.

In some embodiments, the techniques described herein relate to a method, wherein the bent shape further includes one or more flat faces connected to at least one of the plurality of bends.

In some embodiments, the techniques described herein relate to a method, wherein a first bend of the plurality of bends connects a first flat face and a second flat face of the one or more flat faces.

In some embodiments, the techniques described herein relate to a method, wherein the tempered glass piece includes silicate glass.

In some embodiments, the techniques described herein relate to a method for controlling a particle size of a tempered glass piece when broken. In some embodiments, the method includes bending a glass piece into a bent shape having at least one bend, the at least one bend having a degree of bend and a bend radius. In some embodiments, the method further includes immersing the glass piece in molten salt to ion exchange the glass piece to form the tempered glass piece. In some embodiments, at least a time of the glass piece being immersed in the molten salt controls the particle size of the tempered glass piece when broken.

In some embodiments, the techniques described herein relate to a method, wherein bending the glass piece includes heating the energetic glass piece and molding the glass piece into the bent shape.

In some embodiments, the techniques described herein relate to a method, wherein the tempered glass piece includes at least one of soda-lime glass, silicate glass, borosilicate glass, phosphate glass, chalcogenide glass, or germanium glass.

In some embodiments, the techniques described herein relate to a method, wherein the bend radius is greater than 4 inches.

In some embodiments, the techniques described herein relate to a method, wherein the degree of bend is in a range of 15 degrees to 80 degrees.

In some embodiments, the techniques described herein relate to a method, where at least the degree of bend further controls the particle size of the tempered glass piece when broken.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWINGS

Embodiments of the present disclosure are described in detail below with reference to the attached drawing figures, wherein:

FIG. 1 depicts a method in accordance with embodiments of the present disclosure;

FIGS. 2A and 2B illustrate chemically tempered glass pieces before and after breaking; and

FIG. 3 illustrates exemplary curved chemically tempered glass pieces in accordance with embodiments of the present disclosure.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description of embodiments of the present disclosure references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. Therefore, the following detailed description is not to be taken in a limiting sense. The scope of embodiments of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

Embodiments of the present disclosure are generally directed to systems, methods, and apparatuses for controlling the particle size of tempered glass when the tempered glass is broken. A piece of glass may be formed into a bent shape having one or more bends via a bending process, such as slumping. Each bend may have a radius and a degree of bend. After forming the bent shape, the glass may undergo an ion exchange process. The ion exchange process may result in additional compressive stresses within the glass. More specifically, ion exchange may place the outer surfaces of the glass in compression while the interior of the glass is in tension. At the same temperature, a longer ion exchange time may result in smaller particle sizes when the tempered glass is broken. Generally, further stressing the glass may result in both the tempered glass breaking more easily (e.g., requiring less force to break) and into smaller particles. Similarly, by increasing the degree of bend and/or decreasing the bend radius, the tempered glass may be broken more easily and into larger particle sizes. Controlling the particle size of broken glass may be advantageous for various application, such as where the glass may break and harm surrounding persons, animals, or objects.

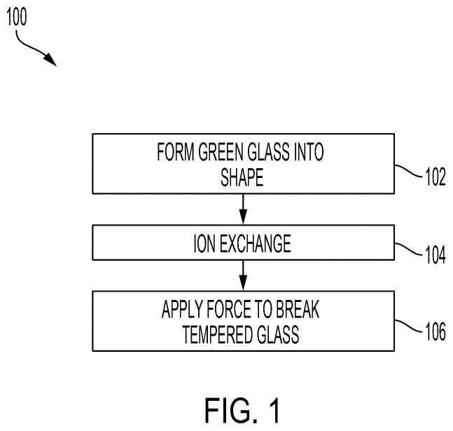

FIG. 1 illustrates a method 100 of producing a tempered glass piece with controlled broken particle size in accordance with aspects of the present disclosure. Method 100 may begin at step 102 where a green glass piece may be formed into a shape. In some embodiments, the green glass piece is formed into a curved or bent shape having one or more bends. Each of the one or more bends may have either or both of a distinct bend angle or a distinct bend radius relative to the other bends in the tempered glass piece.

An increase in the bend angle may result in a decrease in the broken particle size and/or an increase or decrease in the energy released by breaking the tempered glass piece. Accordingly, adjusting the bend angle of the glass piece may adjust or control the particle size and/or the energy released when the tempered glass piece is broken. As used herein, “bend angle” may refer to the total directional change of the glass piece in a bent section. For example, a “bend angle” of 180 degrees may refer to a bend that causes the glass piece to extend in a direction opposite of the initial direction the glass piece was extending, such as a U-shaped bend.

In some embodiments, the bend angle is about 45 degrees or in the range of 40 to 50 degrees. In some embodiments, the bend angle is in the range of 30 to 65 degrees. In some embodiments, the bend angle is in the range of 15 to 80 degrees. In some embodiments, the bend angle is about 90 degrees or in the range of 85 to 95 degrees. In some embodiments, the bend angle is in the range of 60 to 120 degrees. In some embodiments, the bend angle is in the range of 45 to 135 degrees. In some embodiments, the bend angle is about 180 degrees or in the range of 175 to 185 degrees. In some embodiments, the bend angle is in the range of 160 to 200 degrees. In some embodiments, the bend angle is in the range of 145 to 215 degrees. In some embodiments, the bend angle is in the range of 1 to 359 degrees. In some embodiments, the bend angle is in the range of −1 to −359 degrees. Generally, any bend angle may be used. While embodiments of the present disclosure are generally described with respect to a curved piece of tempered glass, it will be appreciated that the tempered glass pieces may be formed with a corner, which may have any of the above-described angles.

Similarly to increasing the bend angle, increasing the bend radius may result in a reduction in the broken particle size and/or a reduction in the energy released by breaking the tempered glass piece. Experimental results providing a showing of the changed release of energy are provided below. Accordingly, adjusting the bend radius of the glass piece may adjust or control the particle size and/or the energy released when the tempered glass piece is broken. For example, a smaller bend radius (e.g., a bend radius of 0.25 inches or 0.50 inches) may break less energetically than a larger bend radius (e.g., a bend radius of 1.50 inches or 3.00 inches). As used herein, “bend radius” may refer to the radius of an imaginary circle (e.g., imaginary circle 210 described further below) made by the bent section of the glass piece if the bend continues to form a circle. For example, “bend radius” may refer to the radius of the imaginary circle made by continuing the bent section of the glass piece and not the radius of the glass piece itself.

In some embodiments, the bend radius is in the range of 0.25 inches (6.35 mm) to 4 inches (101.06 mm). In some embodiments, the bend radius is in the range of 0.5 inches (12.7 mm) to 1.5 inches (38.1 inches). Radii less than 0.5 inches or greater than 4 inches may be employed. For example, the radii may be between about 0.05 inches (1.27 mm) to about 0.25 inches (6.35 mm), or between about 0.1 inches (2.54 mm) to about 0.2 inches (5.08 mm), or the radii may be about 0.05 inches (1.27 mm) or smaller. In another example, the radii may be between about 4 inches (101.06 mm) to about 12 inches (304.8 mm), or between about 6 inches (152.4 mm) to about 10 inches (254 mm), or the radii may be about 12 inches (304.8 mm) or larger. Generally, a bend radius of any size may be used. In some embodiments, the bend radius of the tempered glass may depend at least on the dimension of the glass sheet (e.g., thickness, length, and/or width). For example, the bend radius of the tempered glass may be at least five times the thickness of the glass or at least ten times the thickness of the glass.

In some embodiments, the bending process is a slumping process to modify internal stresses inside the glass piece, including slumping processes of any number of steps (e.g., two). For example, the bending process may be a slumping process to add internal stresses inside the glass piece. The slumping process may involve heating the glass piece in an oven (e.g., a kiln) and over (or into) a mold to form the bent shape. The mold may have a shape corresponding to the final shape of the glass piece such that the glass piece is bent into the desired final shape, as will be appreciated by one of skill in the art. The glass piece may be heated above the transition temperature of the glass, thereby enabling the glass piece to take the shape of the mold. Additionally, or alternatively, the glass piece may be heated above a softening temperature of the glass, thereby enabling the glass piece to take the shape of the mold. Thereafter, the glass may be modified by applying a cooling profile to the glass as will be appreciated by one of skill in the art. Finally, the oven may then be cooled to cool the glass, resulting in the glass piece having the desired shape and modified internal stress.

In some embodiments, the slump time may be selected based on the type of glass and/or the shape of the mold. In some embodiments, the slump time may be at least 30 minutes, at least 1 hour, at least 2 hours, at least 3 hours, at least 4 hours, or at least 5 hours. In some embodiments, a slump time less than 30 minutes or greater than 5 hours may be employed. The slump time may further depend on other factors of the slumping process as will be appreciated by one of skill in the art.

It is contemplated that other methods of forming the glass piece into the bent shape may be employed without departing from the scope hereof. For example, a hot-pressing process may be employed where a positive mold (or other press) presses a heated glass piece into a negative mold to obtain a desired shape. As another example, vacuum forming techniques may be employed.

Next, at step 104, the glass piece may undergo an ion exchange process. The ion exchange process may add compressive stresses to the glass, which may increase the strength of the glass piece. Generally, any method of ion exchange may be employed. For example, the ion exchange may comprise immersing the glass in molten salt. Other methods of ion exchange may include, but are not limited to, ion exchange in a water pressure chamber, gaseous ion exchange, or gel-type ion exchange. Both the length of the ion exchange process and the temperature of the ion exchange process may be adjustable parameters to obtain broken particles of a desired size. Increasing either parameter may result in a more energetic break and smaller particle sizes due to the increase in the compressive stresses added to the tempered glass piece. To state another way, a more energetic break and smaller broken particles may be achieved by inducing higher compressive stresses in the tempered glass piece, which may be done via an ion exchange process.

Accordingly, adjusting the length of time of the ion exchange process and/or the temperature of the ion exchange process of the glass piece may adjust or control the particle size and/or the energy released when the tempered glass piece is broken. In some embodiments, the change of energy released from breaking the tempered glass piece caused by the length of ion exchanging may diminish after a certain time of ion exchanging. For example, the increase of energy released from breaking the tampered glass piece caused by the length of ion exchanging may taper after a certain time. In another example, the increase of energy released from breaking the tampered glass piece caused by the length of ion exchanging may be shaped similarly to a bell curve, such that after a certain time, ion exchanging for a longer time decreases the energy released from breaking the tampered glass piece. In some embodiments, ion exchanging for longer than 32 hours may diminish the increase of energy released from breaking the tempered glass piece. Alternatively, ion exchanging for longer than 32 hours may decrease the energy released from breaking the tempered glass piece compared to ion exchanging for 32 hours. Accordingly, the optimum length of ion exchanging may be within a range of 8 hours to 40 hours, within a range of 8 hours to 32 hours, or within a range of 16 hours to 32 hours. For example, a glass piece may be ion exchanged for a length of 8 hours, 16 hours, 24 hours, 32 hours, or 40 hours. After ion exchanging, the glass piece may become tempered.

As previously discussed, one advantage of the present disclosure is that the use of a bent tempered glass piece may enable the glass to fracture easier (e.g., with less force applied) relative to a flat tempered glass piece. When ion exchanging glass, the compressive stresses strengthen the glass, thereby making it more difficult to fracture. However, by forming the glass piece into a bent shape, the tempered glass piece may become easier to break due to the added stresses from the bend. Accordingly, the present disclosure allows for a tempered glass piece to be formed that has the benefits of chemical strengthening via ion exchange while the bend or bends enable easier fracturing relative to a flat piece of tempered glass.

It is contemplated that other methods of increasing the compressive stresses in the glass to control the particle size of the broken tempered glass pieces are within the scope hereof. For example, thermal tempering and/or other chemical treatment may be employed instead of or in addition to the ion exchanging process. For example, thermal tempering may be employed instead of or in addition to the ion exchanging process.

Moving on, at step 106, the tempered glass piece may be broken, yielding particles of a desired size due to the forming of the tempered glass piece as described with respect to steps 102 and 104. The tempered glass piece may be broken when a force (or other source of energy) is applied to the tempered glass piece. For example, the force may be a mechanical force. As another example, the tempered glass piece may be used in transient electronic systems, and a trigger event (e.g., a localized heating event) may cause the tempered glass piece to break. In some embodiments, the tempered glass piece is tamper-evident glass, and the broken tempered glass piece may indicate that a tampering event had occurred. In some embodiments, the tempered glass piece is fluorescent.

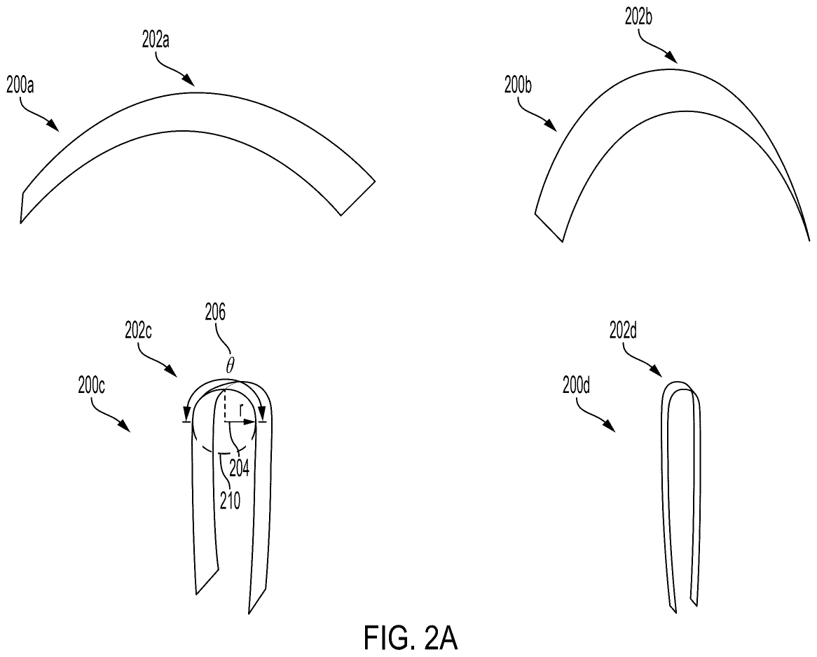

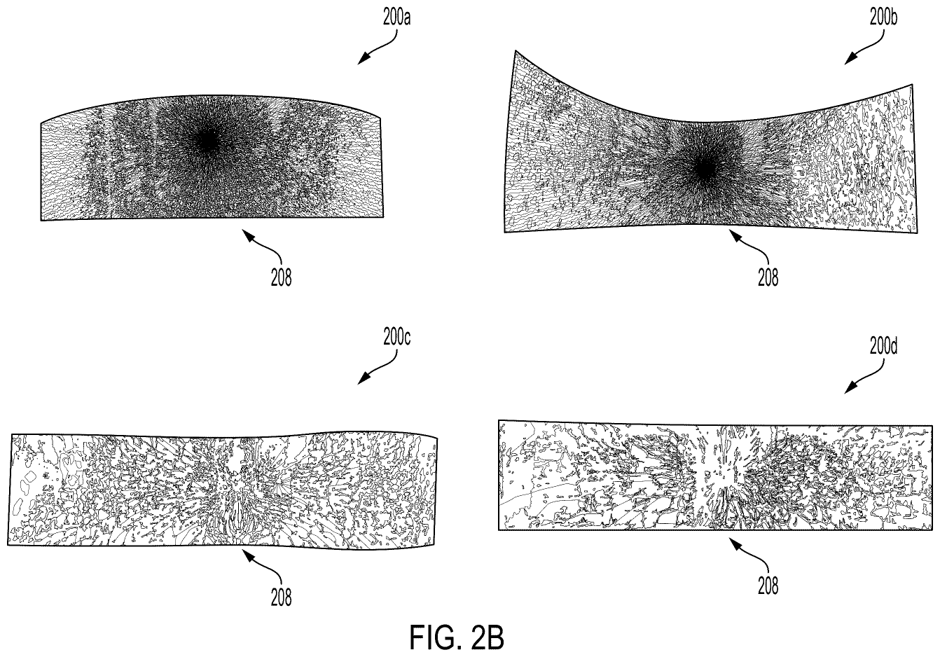

FIG. 2A illustrates four tempered glass pieces 200a, 200b, 200c, and 200d, each having a respective bend 202a, 202b, 202c, 202d. FIG. 2B illustrates the four tempered glass pieces 200a, 200b, 200c, and 200d when broken, illustrating how the radius affects the particle size. Each tempered glass piece 200a, 200b. 200c, and 200d also has a bend radius 204, denoted ‘r’ and a degree of bend 206, denoted ‘θ.’ For example, the degree of bend 206 for tempered glass piece 200c is about 180 degrees (i.e., the glass is formed into a semicircular or U-shape). As described above, the bend angle θ may refer to the total directional change of the glass piece.

Further, as described above, the bend radius r may refer the radius of an imaginary circle made by continuing the bent section of the glass piece to form a circle. Accordingly, imaginary circle 210 is illustrated on tempered glass piece 200c to demonstrate the technique used to calculate the bend radius r. For example, the radius of imaginary circle 210 formed by continuing the bent section of tempered glass piece 200c is 0.5 inches. Tempered glass piece 200a has a bend radius of 3 inches; tempered glass piece 200b has a bend radius of 1.5 inches; tempered glass piece 200c has a bend radius of 0.5 inches; and tempered glass piece 200d has a bend radius of 0.25 inches. As shown in FIG. 2B, the smaller radii tempered glass pieces 200c, 200d break into larger particles or shards 208, while the larger radii tempered glass pieces 200a, 200b break into smaller shards 208. Each glass piece 200a, 200b, 200c, 200d was ion exchanged for the same time and was broken in the same spot on the bend. As discussed above, the resultant particle size could be further controlled by adjusting any of the ion exchange time or the ion exchange temperature.

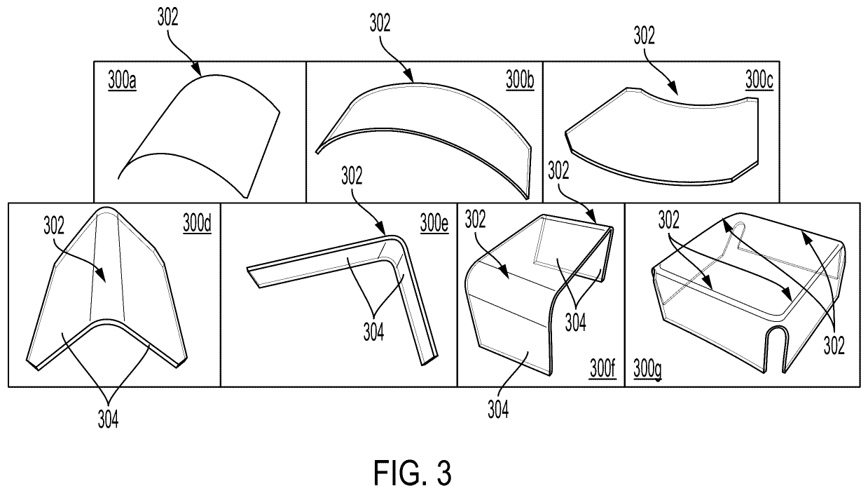

FIG. 3 illustrates exemplary tempered glass pieces 300a, 300b, 300c, 300d, 300e, 300f, and 300g in accordance with certain embodiments of the present disclosure. Each tempered glass piece may have one or more bends 302, and each of the one or more bends may have a radius. As depicted, the tempered glass pieces may be slumped into various shapes, such as entirely curved shapes, e.g., tempered glass pieces 300a, 300b, 300c. In some embodiments, the bend 302 is only in a portion of the tempered glass piece. For example, tempered glass pieces 300d and 300e include a bend 302 that is a transition between two flat faces 304 such that the bend angle θ of 90 degrees. Similarly, tempered glass piece 300f includes two bends 302 that connect three flat faces 304. Lastly, tempered glass pieces 300f and 300g depict how the tempered glass pieces can be formed with multiple bends and into more complicated shapes, such as the open-box shape of tempered glass piece 300g. In some embodiments, the number of bends and/or the location of the bends may affect the energy of breaking the tempered glass piece. For example, tempered glass piece 300g may break more energetically than tempered glass piece 300f.

It will be appreciated that embodiments of the present disclosure are not limited to the shapes depicted in FIG. 3 and that the tempered glass pieces may generally take any geometry. As described, the geometry of bend 302, such as the bend radius, may control the particle size of the tempered glass pieces when broken. For bends 302 of the same radius, increasing the degree of bend may lead to large particle sizes when broken.

In some embodiments, the glass comprises soda-lime glass, silicate glass, borosilicate glass, phosphate glass, chalcogenide glass, or germanium glass. In some embodiments, the tempered glass piece comprises alkali aluminosilicate. In some embodiments, the tempered glass pieces comprise borosilicate glass or any other silicate mixture. Non-silicate-based glass may also be used. In some embodiments, the tempered glass piece comprises fluorescent glass. In some embodiments, the tempered glass piece comprises one or more additional components, such as inorganic fluorescent material or colorants, which may be advantageous to include to indicate a tampering event has occurred.

### EXPERIMENTAL RESULTS

Tempered glass pieces were formed using the techniques described herein to measure the kinetic energy from breaking the tempered glass pieces. Each glass piece was ion exchanged for the same time and was broken in the same spot on the bend. Bend radii of 0.00 inches, 0.25 inches, 0.50 inches, 1.50 inches, and 3.00 inches were tested to indicate the effect of the bend radius of the tempered glass piece on the kinetic energy measured from breaking the tempered glass piece. The kinetic energy measured from breaking the tempered glass piece for each test is shown below in Table 1, and the average kinetic energy measured for each bend radius is shown below in Table 2.

TABLE 1
Kinetic Energy Measured by Breaking Tempered Glass

| | Bend Radius | Kinetic Energy |
|---|---|---|
| Trial Number | (inches) | (Joules) |
| 1 | 0.00 | 0.000336 |
| 2 | 0.00 | 0.000330 |
| 3 | 0.00 | 0.000338 |
| 4 | 0.25 | 0.000011 |
| 5 | 0.25 | 0.000015 |
| 6 | 0.50 | 0.000007 |
| 7 | 0.50 | 0.000108 |
| 8 | 1.50 | 0.001959 |
| 9 | 1.50 | 0.000386 |
| 10 | 3.00 | 0.000835 |
| 11 | 3.00 | 0.000684 |

TABLE 2
Average Kinetic Energy Measured by Breaking Tempered Glass

| Bend Radius | Average Kinetic | |
|---|---|---|
| (inches) | Energy (Joules) | Standard Deviation |
| 0.00 | 0.000335 | 0.000004 |
| 0.25 | 0.000013 | 0.000003 |
| 0.50 | 0.000057 | 0.000071 |
| 1.50 | 0.001172 | 0.001112 |
| 3.00 | 0.000759 | 0.000107 |

As can be seen by the experimental results shown in Table 1 and Table 2, tempered glass pieces having a smaller bend radius (e.g., 0.25 inches and 0.50 inches) broke less energetically compared to tempered glass pieces having a larger bend radius (e.g., 1.50 inches and 3.00 inches). These results are further supported by the sizes of glass shards produced by breaking tempered glass pieces as described above in FIG. 2B. Further, tempered glass pieces having a larger bend radius (e.g., 1.50 inches and 3.00 inches) broke more energetically compared to flat glass pieces (e.g., tempered glass pieces having a bend radius of 0.00 inches). In contrast, tempered glass pieces having a smaller bend radius (e.g., 0.25 inches and 0.50 inches) broke less energetically compared to flat glass pieces. The relationships between the different bend radii and the measured kinetic energy found using the above experimental results are valid based at least on the consistent measurement processes utilized to record the data in Table 1 and Table 2. Further, the consistent magnitudes of the measured kinetic energy demonstrate the effectiveness of the measurement processes utilized to record the data in Table 1 and Table 2.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A method for controlling a particle size of a tempered glass piece when broken, comprising:
slumping a glass piece into a bent shape having at least one bend, the at least one bend having a degree of bend and a bend radius,
wherein the degree of bend controls the particle size of the tempered glass piece when broken; and
ion exchanging the glass piece to form the tempered glass piece.

2. The method of claim 1, wherein the degree of bend is 90 degrees.

3. The method of claim 1, wherein the bend radius is in a range of 0.25 inches to 4 inches.

4. The method of claim 1, wherein the at least one bend comprises two or more bends.

5. The method of claim 4, wherein a first bend of the two or more bends comprises a first degree of bend distinct from a second degree of bend of a second bend of the two or more bends.

6. The method of claim 1, wherein the tempered glass piece comprises alkali aluminosilicate.

7. The method of claim 1, wherein the bend radius is greater than 4 inches.

8. A method for controlling a particle size of a tempered glass piece when broken, comprising:
slumping a glass piece into a bent shape having a plurality of bends, each bend having a degree of bend and a bend radius,
wherein the degree of bend and the bend radius of each bend control the particle size of the tempered glass piece when broken; and
ion exchanging the glass piece to form the tempered glass piece.

9. The method of claim 8, wherein the degree of bend of each bend is in a range of 60 degrees to 120 degrees.

10. The method of claim 8, wherein the bend radius of each bend is in a range of 0.25 inches to 4 inches.

11. The method of claim 8, further comprising heating the glass piece to a softening temperature.

12. The method of claim 8, wherein the bent shape further comprises one or more flat faces connected to at least one of the plurality of bends.

13. The method of claim 12, wherein a first bend of the plurality of bends connects a first flat face and a second flat face of the one or more flat faces.

14. The method of claim 8, wherein the tempered glass piece comprises silicate glass.

15. A method for controlling a particle size of a tempered glass piece when broken, comprising:
bending a glass piece into a bent shape having at least one bend, the at least one bend having a degree of bend and a bend radius; and
immersing the glass piece in molten salt to ion exchange the glass piece to form the tempered glass piece,
wherein at least a time of the glass piece being immersed in the molten salt controls the particle size of the tempered glass piece when broken.

16. The method of claim 15, wherein bending the glass piece includes heating the glass piece and molding the glass piece into the bent shape.

17. The method of claim 15, wherein the tempered glass piece comprises at least one of soda-lime glass, silicate glass, borosilicate glass, phosphate glass, chalcogenide glass, or germanium glass.

18. The method of claim 15, wherein the bend radius is greater than 4 inches.

19. The method of claim 18, wherein the degree of bend is in a range of 15 degrees to 80 degrees.

20. The method of claim 15, wherein at least the degree of bend further controls the particle size of the tempered glass piece when broken.
